(19) United States
(12) Patent Application Publication
(10) Pub. No.: US 2005/0085244 A1
(43) Pub. Date: Apr. 21, 2005

(54) Implementing sms-based value added service

(76) Inventors: Simon Choi, Singapore (SG); Xiao Peng, Beijing (CN); Cao Hong Wei, Beijing (CN)

Correspondence Address: Pehr Jansson, 7628 Parkview Circle, Austin, TX, 78731, US

(21) Appl. No.: 10/496,619

(22) PCT Filed: Nov. 25, 2002
(86) PCT No.: PCT/IB02/04931

(30) Foreign Application Priority Data
Nov. 27, 2001 (CN) 01135096.2

(51) Int. Cl. H04Q 7/20

(52) U.S. Cl. 455/466; 455/558

(57) ABSTRACT

An SMS-based wireless value-added service implementation method and system. The method comprises the steps of: disassembling a wireless value-added service into command identifiers for commands and corresponding information bodies at the service provider side, said information bodies including information required for the commands and service related information; combining each of said command identifiers and corresponding information body into a command body, and inserting a logic sequence identifier that indicates the logic sequence of the commands into the command body, then assembling the command bodies into a short message. The service server sends the short message to the mobile terminal, and the interpretation program in SIM card of the mobile terminal interprets the short message into corresponding commands and information which have a logical sequence and can be executed in the mobile terminal. The mobile terminal executes the commands based on the logic sequence, and displays the information. Wireless value-added service can be available through pushing, web customization and downloading with mobile terminal.

### TECHNICAL FIELD

The present invention relates to a method and system for implementing SMS-based wireless valued-added services, especially to a method and system for downloading wireless service information from a service provider by use of short message technology, storing it into the subscriber identity module (SIM) card of a mobile terminal, and providing the corresponding management function.

### BACKGROUND ART

It is possible to load in a SIM card an application that defines a menu, a data-input interface and a data format for communicating with a service provider. A customer selects a desired service through the menu and inputs the required data via the data input interface. The application organizes the data into a fixed format in order to send that data to a value-added service platform of carrier over a GSM network. The application is pre-configured when SIM card is produced.

There is a need to change applications contained on a SIM card because customer demand changes and new applications emerge. Several methods are available: (1) A user gets a new SIM card that supports new applications at the PoP (Point of Presence) of mobile carriers or reloads new applications into the existing SIM card. This method needs special device and software system support; (2) use over-the-air (OTA) download technology to download the service menu, service data input interface and service data delivery format required in the SIM card from the wireless value-added service platform to the SIM card; (3) build a browser on the mobile terminal equipment to locate all the data related to the application at a service server. Users can access various functions defined by the applications through interaction with the service server.

Each of the above methods has certain limitations. For the first method, even though the mobile user is interested in new applications, he/she might find it is inconvenient to go to the PoP of the mobile carrier to replace the SIM card; For the second method, a new service generally requires to download a large amount of data, whereas one short message can only carry limited data For the third method, it requires the mobile terminal requires to interact with the service provider, which is relatively time consuming. Even a simple application might involve complicated operations. The process might become particularly slow when the number of users reaches a certain critical level.

Therefore, there is a need to improve the updating of a wireless service on a SIM card, in particular to make it more flexible and more convenient.

### SUMMARY OF THE INVENTION

To solve the above problems, the object of the present invention is to provide a method and system for implementing SMS-based wireless value-added service, in which the service related information, commands indicated by command identifiers, and the least information for commands are extracted from the entire commands and information of a value-added service, encapsulated into a short message, and sent to the mobile terminal for one time without repeatedly interaction of user with service provider, that is, a fully executed menu can be formed at the mobile terminal.

To achieve the above object, the present invention provides a SMS-based wireless value-added service implementation method, comprising the following steps: disassembling a wireless value-added service into command identifiers for commands and corresponding information bodies at the service provider side, said information body including information required for the commands and service related information; combining each of said command identifiers and the corresponding information body into a command body, inserting a logic sequence identifier that indicates the logic sequence of the commands into the command body, assembling the commands bodies to makeup a short message; sending the short message to the mobile terminal from said service provider; and an interpretation program in SIM card of the mobile terminal interprets the short message into the corresponding commands and information that have said logic sequence and can be executed in the mobile terminal.

In addition, the present invention provides a system for implementing SMS-based wireless value-added services, comprising: a wireless value-added service server at a service provider side for disassembling a wireless value-added service into command identifiers for commands and corresponding information bodies, said information bodies including information required for the commands and service-related information; combining each of the said command identifiers and the corresponding information body into a command body, and inserting a logic sequence identifier that indicates logic sequence of the commands into the command body, assembling the command bodies into a short message, and sending the short message to a mobile terminal; and a SIM card for storing an interpretation program for interpreting said short message received from said wireless value-added server into corresponding commands and information which have a logic sequence and can be executed by the mobile terminal.

The present invention eliminates a large number of redundant information and codes in the transmission process. Accordingly, the amount of useful information carried in one short message is significantly increased, leading to a higher delivery efficiency of the short message. For a common wireless service, a user can download the service to a SIM card by communicating with service provider only once, and access the service at any time later. The user can send short messages directly using the mobile terminal, or customize his preferred service through a WEB page. When a new application is introduced, the service provider can send the menu data (short messages) of the new wireless service to subscribers via the service provider for selection by the subscribers. The subscribers can also remove the downloaded application and request for a new service through the management function provided by a resident program.

### BRIEF DESCRIPTION OF THE DRAWINGS

These and other objects, features and advantages will be illustrated in the detailed description with reference to the drawings, in which:

FIG. 1 illustrates a network system in accordance with the invention based on a Network Operator structure.

FIG. 2 is illustrates a network system in accordance with the invention based on an Internet Content Provider structure.

FIG. 3 is a system block diagram of an embodiment according to the present invention.

FIG. 4 is the flow chart to register new wireless service according to the present invention.

FIG. 5 is the flow chart to release a service.

FIG. 6 is the flow chart to book a service by a Web Page.

FIG. 7 is the flow chart to book a service by a mobile terminal.

FIG. 8 is the flow chart of the operation of the interpretation program in a SIM Card.

FIG. 9 is a menu structure diagram of an embodiment of the invention.

### BEST MODE FOR CARRYING OUT THE INVENTION

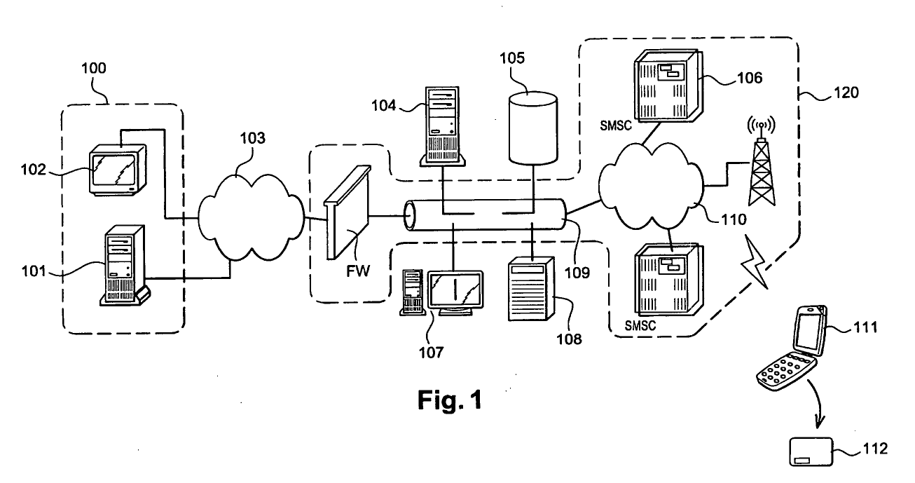

FIG. 1 illustrates a network system that includes: an internet content provider (ICP) network 100 which consists of a ICP application server 101 and a ICP web server 102; Internet 103; an application server 104, which can send the wireless service in short message format to a SMSC (short message service center); an application database 105 for storing wireless services, various requests, and logs etc; a mobile operator network 120 which consists of a SMSC 106, a GSM Network 110, a telecommunication data network 109, and firewall & Getaway (FW); an operation, application and management (OAM) server 107 which offers the functions of configuration, management, maintenance etc; an authentication & billing server 108 for providing authentication and billing information for subscribers, ICPs, and operators; a mobile phone or a car phone 111; and a SIM card 112 which supports Java virtual machine.

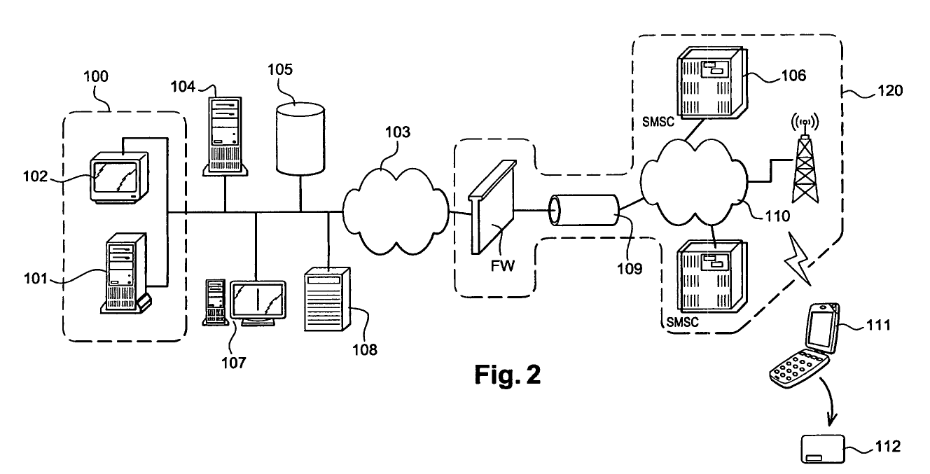

FIG. 2 has the same components indicated by the identical references as FIG. 1 except for a different topology, which will not be described in details.

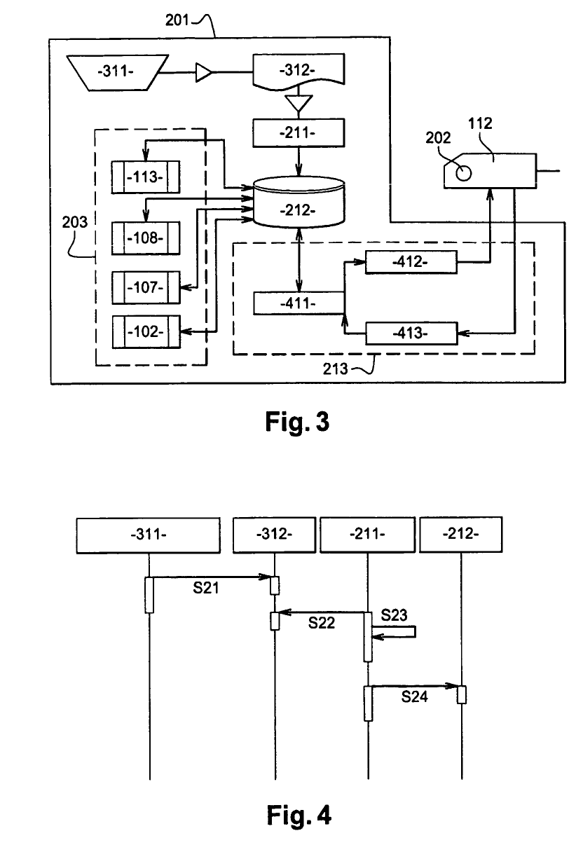

FIG. 3 is the system block diagram of an embodiment according to the present invention. The system comprises: a wireless value-added service server 201, which includes a plurality of wireless value-added services, for disassembling each wireless value-added service into a group of commands and the corresponding information bodies, each of said information bodies includes information required for the command and service related information; combining each of said commands and the corresponding information body into a command body, inserting the logic sequence identifier that indicates the logic sequence of said commands into the command body, and assembling the command bodies to makeup a short message, said wireless value-added server sending the corresponding short message to a mobile terminal based on various wireless service requests; a SIM card 112 for storing an Applet (an interpretation program) 202 for interpreting the short message received from said wireless value-added service server into corresponding commands and information which have a logic sequence to be executed by the mobile terminal; and a general sever group 203 for offering the functions of access to network, service release, management, maintenance, authentication and billing etc.

Specifically, the wireless value-added service server 201 includes: a simulator & wireless service script generator 311 for disassembling a wireless value-added service into a plurality of command bodies to generate a wireless service script which is the data file based on XML, and the data file is converted from a Web page, and authenticate and simulate the script, the wireless service script contains all command bodies mentioned above; a short message generator 211 for processing the script file to form a short message which will be stored into an application database 212 which can be a database supporting SQL standard; the application database 212 for storing the information such as wireless services, various requests, and the logs etc; a service request handle module 213 for processing the wireless service requests sent from the Web server or mobile terminals, or reading the corresponding short messages from the database according to the PUSH command actively sent from the application sever 104 to send. Said generator contains a command identifier-command mapping list for mapping each of the codes of the commands into a corresponding command identifier. It is the command identifier that is put into the short message, not the longer codes of the command itself, to save the data amount in the short message. The same command identifier-command mapping list is also stored in the SIM card in advance.

The command identifier-command mapping list is as follows, for example:
01 the command to display a text
02 the command needing to be input by the user
03 the command to send short messages
04 ... ...
...... ... ...

The service request handle module 213 comprises: a short message receiver 413; a short message sender 412; and a guard server 411 for accessing the database 212, calling the short message receiver 413 to store the service request sent from a mobile terminal by a subscriber into the database 212, and calling the short message sender 412 to forward the corresponding short messages to the SIM card 112 of the subscriber.

The general server group 203 comprises: a Web server 102 for providing user interface by web page for subscribers, and submitting the wireless service requests selected by the subscribers to the database 212; an OAM server 107 for offering the functions of configuration, management and maintenance for the subscribers; an authentication & billing server 108 for providing authentication and billing information for subscribers, ICPs, and carriers, and a service release server 113 for offering the release function of service application for ICPs.

The following is the implementing of the method according to the present invention.

FIG. 4 is a flow chart to register new wireless service according to the present invention. In Step S21 of the FIG. 4, the simulator & wireless service script generator 311 disassembles a wireless value-added service into multiple commands and the respective corresponding information bodies, said information bodies including information required for the commands and service related information, combines each of said commands and the corresponding information body into a command body, inserts the logic sequence identifier that indicates the logic sequence of commands into the command body to generate the wireless service script 312 which is authenticated and simulated by the simulator to guarantee the menu formed at the mobile terminal side from the generated script is correct. In Step S22, the short message generator 211 reads the script file 312 generated by the simulator & wireless service script generator 311, analyzes and processes it, then generate a short message in Step S23. After the wireless service short message is generated, In Step S24, the short message generator 211 stores the generated short message into the database 212.

The ICP can actively send the PUSH command from the service release server 113 to provide new wireless services to users.

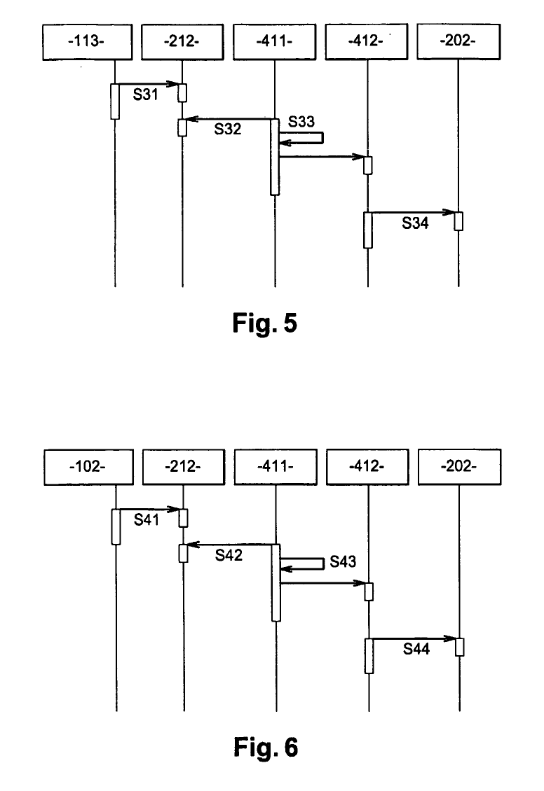

As shown in FIG. 5, in Step S31, the service release server 113 sends a service release request to the application database 212. In Step S32, the guard server 411 monitors the service release request from the application database 212 and extracts the required short message of the wireless service from the application database 212. In Step S33, the guard server 411 distributes and forwards the short message, and calls the short message sender 412. In Step S34, the short message sender 412 sends the short message to the applet 202 residing in the SIM card (the process of the wireless service short message operated by the applet in the SIM card will be described later).

In addition, the user can submit a booking request to the Web sever 102 when browsing the web page customized for the value-added service by the ICP to obtain the required wireless value-added service.

As shown in the FIG. 6, in Step S41, the Web server 102 sends a wireless value-added service request to the application database 212. In Step S42, the guard server 411 monitors the wireless value-added service request from the application database 212 and extracts the required short message of wireless service from the application database 212. In Step S43, the guard server 411 distributes and forwards the short message, and calls the short message sender 412. In Step S44, the short message sender 412 sends the short message to the applet 202 residing in the SIM card (the process of the wireless service short message operated by the applet in the SIM card will be described later).

The user can also send a request of booking a new service through the applet 202 in the SIM card, which is sent through the Mobile 111 firstly, then GSM network 110 to the wireless value-added service server 201, to obtain the required wireless value-added service.

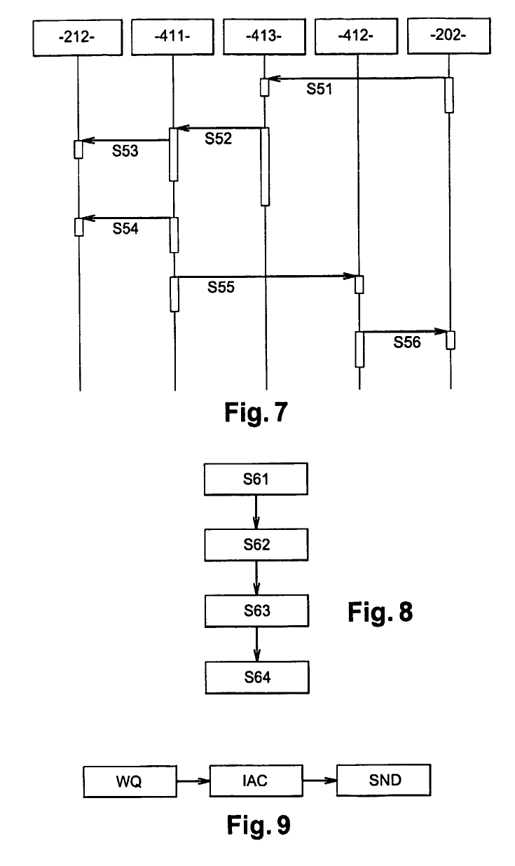

As shown in the FIG. 7, in step S51, the applet 202 residing in the SIM card sends a request for the wireless value-added service in form of short message to the short message receiver 413. In step S52, the short message receiver 413 forwards the request message to the guard server 411. In Step S53, the guard server 411 stores the short message of the request into the application database 212. In step S54, the guard server 411 monitors the wireless value-added service request from the application database 212 and extracts a wireless service short message corresponding to the request from the application database 212. In step S55, the guard server 411 distributes and forwards the short message, and calls the short message sender 412. In step S56, the short message sender 412 sends the short message to the applet 202 residing in the SIM card (the process of the wireless service short message operated by the applet in the SIM card will be described later).

The applet 202 in the SIM card is an interpretation program for interpreting and processing the wireless service short message as follows.

As shown in the FIG. 8, in step S61, the SIM card 112 receives the wireless service message. In step S62, the applet 202 saves the wireless service short message as a SIM card file. In step S63, the applet 202 converts the saved application information into corresponding commands in the form of menu, which are displayed on the mobile phone in a designated logical sequence therein. Specifically, there is saved in the SIM card in advance the same command identifier-command mapping list (not shown) as that in the service provider, as well as the redundant information corresponding to each of the commands. The applet 202 converts or maps the commands into the respective command codes, and adds in the corresponding redundant information, so as to send the complete commands which are compliant with GSM specification to the mobile phone after the conversion and addition. In step S64, the mobile phone executes the corresponding operations, that is, interpreting the short message into a menu, displaying the menu on the mobile phone to execute deleting and applying for new services to complete the functions defined by the wireless service.

Next, the method for extracting the command identifier, necessary information for the commands, and service-related information will be described in conjunction with an embodiment.

For example, a command for selection, which is compliant with GSM specification, is shown as follows:

| | |
|---|---|
| Protective SIM Command Tag | “D0” |
| Length | “ ” “calculated automatically” |
| Command Details | |
| Tag | “81” |
| Length | “03” |
| Command Number | “01” |
| Type of command | “24” |
| Command qualifier | “00” |
| Device identitiesbodies | |
| Tag | “82” |
| Length | “02” |
| Source device identity | “81” |
| Destination device identity | “82” |
| Item content | |
| Tag | “8F” |
| Length | “0A” |
| ItemId | “01” |
| ItemValue | “808BDD8D3967E58BE2” |

In the conventional OTA mobile downloading application, all information (including the necessary information and redundant information) on the above commands must be included into the short message to send, but the necessary information in the commands in the above form is only the least part thereof (for example, the underlined part in the example), the others are redundant information. Therefore, the effective data which can be contained in the short message is much less, so it is very difficult to place one service into one short message. Further, the codes of the commands themselves are relative longer, which often results in errors during transmission and erroneous menu at the mobile phone. In the present invention, only the necessary data (the data underlined in the example) to complete the command are extracted at the service provider, for example, “00” is a command qualifier, “00” and “01” is the necessary information to complete the command, and “808BDD8D3967E58BE2” (ItemValue) is the service-related information to complete the command. Only the necessary information for the commands and service-related information are put into the information body which constitutes a command body by adding the above command identifier. Due to excluding redundant information, the data required for transmitting the command is dramatically reduced, and the effective data which can be contained in the short message and the efficiency of the short message are increased.

In addition, in accordance with the present invention, since the mobile terminal such as mobile phone understands only the commands compliant with GSM specification, before being used by the mobile terminal, the short messages are interpreted by the applet in the SIM card, and the redundant information which is excluded in the short message but necessary for the execution of the mobile phone, such as the codes of “81” (Tag), . . . “8F” (Tag) mentioned above, are supplemented by the applet during the interpretation to form the complete commands which can be executed by the mobile terminal and be compliant with GSM specification. The redundant information corresponding to each command is stored in the SIM card in advance.

Thus, for each command, 20 bytes length or more which is taken in the short message can be saved. In the limited length of a short message (140 bytes for GSM Specification), can a complete service which has more commands be accommodated. If there is a larger wireless value-added service, the remained parts of all commands and the corresponding information bodies of said wireless value-added service, which can not be accommodated in one short message, can be placed in other at least one short message, sequence identifiers for linking each short message are inserted into said each short message, each of said short message is sent to the mobile terminal, and the applet in SIM card of the mobile terminal combines said each short message and interprets said each short message into corresponding commands and information which have a logic sequence and can be executed in the mobile terminal. For other communication systems, said short message can be one of the short messages which are compliant with CDMA, or GPRS specifications.

The format of the short message and the above completing process will be explained in conjunction with a particular example as follows.

For instance, there is a wireless service named “WeatherQuery” as shown in FIG. 9, which has 3 commands: “WeatherQuery (WC)->Input Area Code (IAC)->Send (SND)”. Firstly, there is text display “WeatherQuery”, the codes of its command body are “0100028FOA018059296C1467E58BE2”, in which the first “01” is a command identifier indicating that it is a command to select text display; the following “00” is a command qualifier indicating the necessary information to complete the command; the following “02” is the identity of next action, that is the above logic sequence identifier indicating the logic sequence between commands; the “8FOA018059296C1467E58BE2” is the necessary service-related information, which can be added onto the menu list for selection by users.

If the text display ““WeatherQuery” is selected, the second action “Input Area Code” will be taken, the codes of its command body are: “0200038D09088F935165533A53F791020305”, in which the first “02” is a command identifier indicating that it is a command which needs to be input by the user; the following “00” is a command qualifier indicating the necessary information to complete the command; the following “03” is the identity of next action, that is the above logic sequence identifier indicating the logic sequence between commands; the “8D09088F935165533A53F791020305” is the necessary service-related information. At this point, the mobile phone is waiting for the input of the area code of the city to be queried by the user.

When the user completes the input of the area code of the city to be queried, the next action “Send” will be taken, the codes of its command bodies are “03008B0B0100038161F80004025451”, in which the first “03” is a command identifier indicating that it is a command which sends the short message and does not need to be inserted the logic sequence identifier; the “008B0B0100038161F80004025451” is the necessary information to complete the command. Then, the information identifying the starting location and length in which the data of each step are stored is added in the front, the information of each step is indicated with two bytes, and coded as follows:
0F0612150F27
OF the length of the information code of the first step
06 the starting location of the information code of the first step
12 the length of the information code of the second step
15 the starting location of the information code of the second step
0F the length of the information code of the third step
27 the starting location of the information code of the third step

Finally, the information head which contains applied related information is added.

The complete codes are as follows:
“010000F0612150F270100028F0A018059296C1467E58BE20200038D09088 F935165533A53F79102030503008B0B0100038161F80004025451”.

The mobile phone can send the Area Code input by the user to the wireless value-added service provider 201 to process. Thus, the service application at the mobile phone is completed.

Before the user applies for the wireless service short messages, the wireless value-added service provider generates wireless service script 312 using the simulator & wireless service script generator 311 of the wireless value-added service provider 201, which can be data file based on XML. An instance of the wireless service script is as follows:

<?xml version=“1.0” encoding=“GB_2312-80”?>
<xml>
<menu id=“cn_weather”>

<description> chinese weather broadcast menu </description>
<interactive>0</interactive>
<vas_name>c_swas</vas_name>
<dcs>8</dcs>
<action id=“1” >

<type>1</type>
<qualifier>0</qualifier>
<jump>2</jump>
<item> WeatherQuery</item>

</action>
<action id=“2” >

<type>2</type>
<qualifier>0</qualifier>
<jump>3</jump>
<input> Input Area Code</input>
<min>2</min>
<max>4</max>

</action>
<action id=“3” >

<type>3</type>
<qualifier>1</qualifier>
<send id = “168”>TQ</send>

</action>

</menu>
</xml>

Then, the script 312 is converted into a wireless service short message by wireless service short message generator 211, and put into the database. The short message can be a short message which is compliant with one of the GSM, CDMA, GPRS specifications. The generated short message is as follows:

“0100000F0612150F270100028F0A018059296C1467E58BE20200038D09088 F935165533A53F79102030503008B0B0100038161F80004025451”.

For other wireless service applications, such as securities transaction, traffic information, price information etc., similar short messages can be generated. If it is necessary, the information can also be encrypted.

Then, users can send the requests downloading the service at WEB sever through Internet or a mobile phone, finally said requests will be transmitted to the service request handle module 213 of the wireless value-added service provider 201. After it receives the requests, the service request handle module 213 takes out the encoded wireless service short message from application database 212 to send it to the user of the mobile phone. In addition, the value-added service provider can push the application service to the mobile phone of the user by directly using this module without the users requests.

After being received by the mobile phone, the wireless service message is transmitted to applet residing in the SIM card, and saved as the files in the SIM card. When the user uses the applet in the SIM card next time, the identifier “WeatherQuery” of the downloaded application service can be dynamically added into the service menu list, and when the user selects the service identifier from the list, the applet interprets the saved information into logic actions which have a certain logic sequence to complete the menu function defined by the application service.

Therefore, in accordance with the above description, only once needed to communicate with the service provider, the users can download the application service onto the SIM card, and use it at any time later.

Although the preferred embodiments have been described as above, but the descriptions is only for the object of the explanation, and it should be understood that the present invention can be made into various changes and modifications within the scope of the principles of the claims as attached.

For example, the invention may alternatively be summarized as follows. An application is loaded onto a carrier, preferably a SIM, via a communication channel, preferably a message service. When activated, the application causes the carrier (SIM) to apply a sequence of commands to a host device, for example a mobile phone.

The application is composed of command bodies. A command body comprises:
a command identifier that identifies a particular command;
a sequence identifier that indicates the position of the command in the sequence of commands; and
data necessary to execute the command as well as service-related data.

The command body thus does not comprise “redundant” data=data that is not necessary to execute the command but that should still be part of the command for reasons of conformity with the relevant standard or environment.

The carrier (SIM) comprises an applet that interprets the application so as to obtain commands that the carrier (SIM) can apply to the mobile and the mobile can execute.

The invention thus allows faster and more reliable loading. The application comprises relatively few bytes because redundant information that is normally present in a SIM-to-mobile command is removed. The applet restores the redundant information so as to obtain a SIM-to-mobile command in conformity with the standard (GSM).

1. A service implementation method, comprising the following steps:
disassembling a service into command identifiers for commands and corresponding information bodies, said information body including information required for the commands and service related information;
combining each of said command identifiers and the corresponding information body into a command body, inserting a logic sequence identifier that indicates the logic sequence of the commands into the command body, assembling the commands bodies to makeup a message;
sending the message to a SIM card present in a mobile terminal; and
an interpretation program in the SIM card interprets the short message into the corresponding commands and information that have said logic sequence and can be executed in the mobile terminal.

2. The method as set forth in claim 1, wherein a service provider and the SIM card have a same command identifier-command mapping list, said service provider converts the commands contained in wireless value-added service into corresponding command identifiers according to said command identifier-command mapping list, and said interpretation program in said SIM card interprets the command identifiers in the short message into corresponding commands according to said command identifier-command mapping list.

3. The method as set forth in claim 2, wherein redundant information required for the commands are stored in said SIM card in advance, when interpreting the short message, the interpretation program adds the redundant information into the corresponding commands to form a complete command that can be executed by the mobile terminal.

4. The method as set forth in claim 1, further includes the steps of:
placing the remained parts of the complete commands and the corresponding information bodies for a wireless value-added service which can not be accommodated in one message into other at least one message;
inserting sequence identifiers for linking the messages into each of said messages;
sending the each message to the mobile terminal; and
said interpretation program in SIM card of the mobile terminal assembling said messages and interpreting into corresponding commands and information which have a logic sequence and can be executed by the mobile terminal.

5. The method as set forth in claim 1, wherein a service provider sends the message to the mobile terminal based on a PUSH command from a service release server.

6. The method as set forth in claim 1, further comprising the step of: a said service provider sending the short message to the mobile terminal based on the request from a WEB server, which is submitted by a subscriber to the WEB server via the WEB page customized by said service provider for the wireless value-added service over Internet.

7. The method as set forth in claim 1, further comprising the step of: a service server sending the short message to the mobile terminal based on the request from mobile terminal.

8. A system for implementing services, comprising:
a service server for disassembling a service into command identifiers for commands and corresponding information bodies, said information bodies including information required for the commands and service-related information; combining each of the said command identifiers and the corresponding information body into a command body, and inserting a logic sequence identifier that indicates logic sequence of the commands into the command body, assembling the command bodies into a message, and wireless sending the short message to a mobile terminal; and
a SIM card for storing an interpretation program for interpreting said message received from said wireless value-added server into corresponding commands and information which have a logic sequence and can be executed by the mobile terminal.
